(19) United States
(12) Patent Application Publication
(10) Pub. No.: US 2013/0184406 A1
(43) Pub. Date: Jul. 18, 2013

(54) RESIN COMPOSITION AND MANUFACTURING PROCESS THEREFOR

(71) Applicants: Daichi Miyazaki, Otsu-shi (JP); Kazuto Miyoshi, Otsu-shi (JP); Masao Tomikawa, Otsu-shi (JP)

(72) Inventors: Daichi Miyazaki, Otsu-shi (JP); Kazuto Miyoshi, Otsu-shi (JP); Masao Tomikawa, Otsu-shi (JP)

(73) Assignee: TORAY INDUSTRIES, INC., Tokyo (JP)

(21) Appl. No.: 13/824,223

(22) PCT Filed: Sep. 8, 2011
(86) PCT No.: PCT/JP2011/070486

§ 371 Date: Mar. 15, 2013

(30) Foreign Application Priority Data
Sep. 28, 2010 (JP) 2010-216630

(51) Int. Cl. C09D 177/12

(52) U.S. Cl. CPC C09D 177/12
USPC 524/600

(57) ABSTRACT

A polyamic acid resin composition includes (a) a polyamic acid having structures represented by general formula (1) in an amount of at least 80% of all the repeating units and (b) a solvent. In formula (1), A is a polyamic acid block represented by general formula (2); B is a polyamic acid block represented by general formula (3); and k is a positive integer. In formula (2), Ws are divalent organic groups having two or more carbon atoms, mainly composed of divalent organic groups represented by general formula (4); Xs are tetravalent organic groups having two or more carbon atoms. In formula (3), Ys are divalent organic groups having two or more carbon atoms, exclusive of the groups represented by formula (4); Zs are tetravalent organic groups each having two or more carbon atoms, and are mainly composed of tetravalent organic groups represented by general formula (5) or (6).

### TECHNICAL FIELD

The present invention relates to polyamic acid resin compositions. Particularly, it relates to a polyamic resin composition to be used suitably for, e.g., flexible substrates of a flat-panel display, an electronic papers, and a solar battery, a surface protective coat of a semiconductor element, a dielectric film among layers, an insulation layer or spacer layer of an organic electro-luminescence device (organic EL element), a planarization layer of a thin film transistor substrate, an insulation layer of an organic transistor, a flexible printed circuit board, and a binder for electrodes of a lithium ion secondary battery.

### BACKGROUND ART

Organic films are advantageous in that they are more flexible and less prone to rupture in comparison to glass. Recently, there is an increasing move toward rendering displays more flexible by replacing the substrates of flat display panels from conventional glass to organic films.

In the event that a display is produced on an organic film, a process is common in which the organic film is formed on a substrate and the organic film is peeled off from the substrate after the production of a device. An organic film can be formed on a substrate by the following methods. One example is a method in which an organic film is stuck on a glass substrate with an adhesive (e.g., Patent Document 1). Another example is a method in which a substrate is coated with a solution containing a resin or the like as a raw material of a film and then the solution containing them is cured by heat or the like to form a film (e.g., Patent Document 2). The former needs to provide the adhesive between the substrate and the film and, therefore, the following process temperature may be limited by the thermal resistance of the adhesive. Conversely, the latter is advantageous in that no adhesive is used and that the film formed is low in surface roughness.

Examples of the resin to be used for an organic film include polyester, polyamide, polyimide, polycarbonate, polyethersulfone, acrylic resin, and epoxy resin. Of these, polyimide is suitable for a display substrate as a highly heat-resistant resin. When forming polyimide by the above-mentioned coating method, there is used a method in which a solution containing a polyamic acid as a precursor is coated and then cured, thereby being converted into polyimide.

Polyimides comprising a combination of pyromellitic dianhydride or benzophenone tetracarboxylic dianhydride and diaminobenzanilides are known to have high thermal resistance, such as low coefficient of thermal expansion and high glass transition temperature (e.g., Patent Documents 3 and 4). When a polyimide has a low coefficient of thermal expansion, the difference from the coefficient of thermal expansion of a glass substrate (3 to 10 ppm/° C.) will become smaller and the warpage of a substrate produced in processing a polyimide into a film will be reduced. However, a solution of a polyamic acid, which is a precursor to such a polyimide, had a problem that the viscosity thereof decreased with time. Therefore, it was unsuitable to be used as the above-mentioned coating agent.

### PRIOR ART DOCUMENTS

### Patent Documents

Patent Document 1: Japanese Patent Laid-open Publication No. 2006-091822 (claims 1, 2, and 7)
Patent Document 2: Japanese Patent Laid-open Publication (Translation of PCT Application) No. 2007-512568 (claim 29)
Patent Document 3: Japanese Patent Laid-open Publication No. 62-81421 (Claims)
Patent Document 4: Japanese Patent Laid-open Publication No. 2-150453 (Claims)

### SUMMARY OF THE INVENTION

### Problems to be Solved by the Invention

In light of the above-described problems, an object of the present invention is to provide a polyamic acid resin composition which exhibits excellent storage stability and which can afford a thermally treated film having excellent heat resistance.

### Solutions to the Problems

The present invention is a resin composition comprising (a) a polyamic acid which comprises structures represented by general formula (1) in an amount of at least 80% of all the repeating units and (b) one or some solvents,

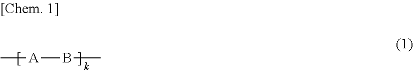

wherein in general formula (1), A is a polyamic acid block represented by general formula (2); B is a polyamic acid block represented by general formula (3); and k is a positive integer,

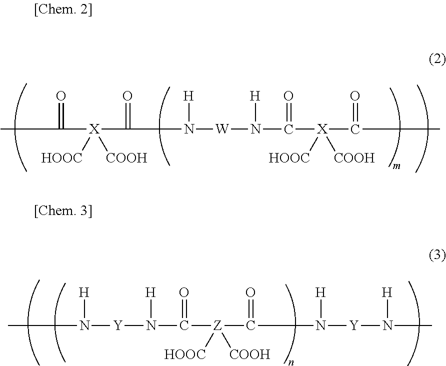

wherein in general formula (2), Ws are divalent organic groups each having two or more carbon atoms and are mainly composed of divalent organic groups represented by general formula (4); Xs are tetravalent organic groups each having two or more carbon atoms, exclusive of the groups represented by general formulae (5) and (6), while in general formula (3), Ys are divalent organic groups each having two or more carbon atoms, exclusive of the groups represented by general formula (4); Zs are tetravalent organic groups each having two or more carbon atoms and are mainly composed of tetravalent organic groups represented by general formula (5) or (6); in general formulae (2) and (3), ms and ns are positive numbers respectively, and may be respectively different among blocks,

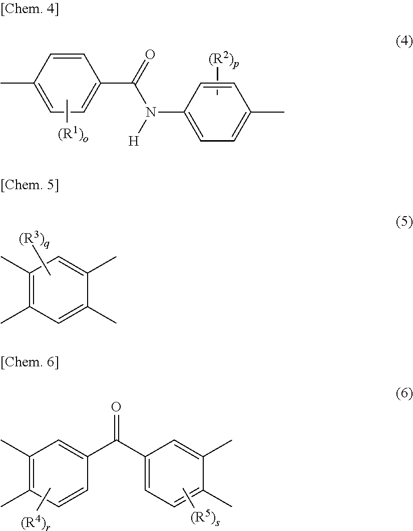

wherein in general formulae (4) to (6), R¹ to R⁵ may be each a single monovalent C₁₋₁₀ organic group or a mixture of different monovalent C₁₋₁₀ organic groups; o and p are each an integer of 0 to 4; q is an integer of 0 to 2; and r and s are each an integer of 0 to 3.

### Effects of the Invention

According to the present invention, it is possible to obtain a polyamic acid resin composition which exhibits excellent storage stability and which can afford a thermally treated film having excellent heat resistance.

### EMBODIMENTS OF THE INVENTION

The resin composition of the present invention comprises (a) a block copolymer polyamic acid which comprises structures represented by general formula (1) in an amount of at least 80% of all the repeating units. The resin composition of the present invention preferably contains structures represented by general formula (1) in an amount of at least 90%, more preferably at least 95%, of all the repeating units, and most preferably, all the repeating units are of the structures represented by general formula (1),

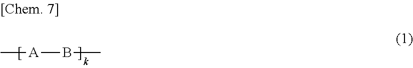

wherein in general formula (1), A is a polyamic acid block represented by general formula (2); B is a polyamic acid block represented by general formula (3); and k is a positive integer,

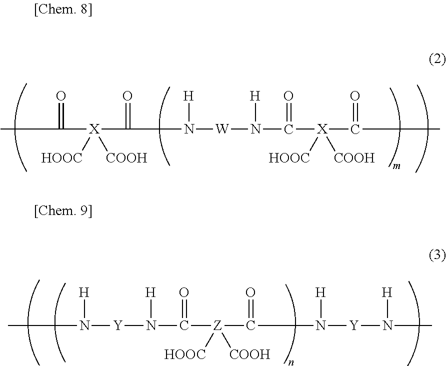

wherein in general formula (2), Ws are divalent organic groups each having two or more carbon atoms and are mainly composed of divalent organic groups represented by general formula (4); Xs are tetravalent organic groups each having two or more carbon atoms, exclusive of the groups represented by general formulae (5) and (6), while in general formula (3), Ys are divalent organic groups each having two or more carbon atoms, exclusive of the groups represented by general formula (4); Zs are tetravalent organic groups each having two or more carbon atoms and are mainly composed of tetravalent organic groups represented by general formula (5) or (6); in general formulae (2) and (3), ms and ns are positive numbers respectively and may be respectively different among blocks,

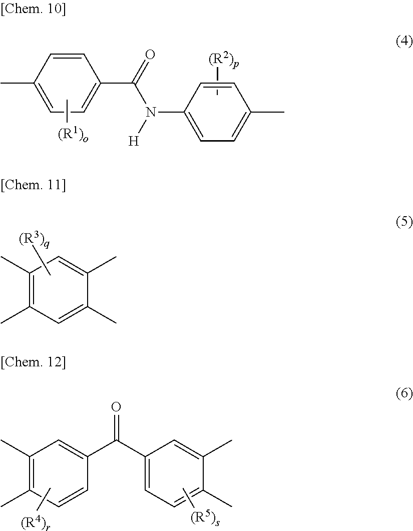

wherein in general formulae (4) to (6), R¹ to R⁵ may be each a single monovalent C₁₋₁₀ organic group or a mixture of different monovalent C₁₋₁₀ organic groups; o and p are each an integer of 0 to 4; q is an integer of 0 to 2; and r and s are each an integer of 0 to 3.

A polyamic acid can be synthesized through a reaction of a diamine compound and an acid dianhydride as described below. W and Y in general formulae (2) and (3) are each a structural constituent of a diamine compound, and X and Z are each a structural constituent of an acid dianhydride.

Ws in general formula (2) are mainly composed of divalent organic groups represented by general formula (4). R¹ and R² are each an organic group having 1 to 10 carbon atoms, examples of which include hydrocarbon groups having 1 to 10 carbon atoms, alkoxy groups having 1 to 10 carbon atoms, and the foregoing groups with one or some hydrogen atoms have been substituted with halogen or the like. Examples of diamine compounds capable of having such a configuration include 4,4′-diaminobenzanilide and its substituted derivatives. Of these, 4,4′-diaminobenzanilide is preferred in terms of easy availability due to wide commercial availability. It is preferred to use as W the divalent organic group represented by general formula (4) in a proportion of at least 50%. The proportion is more preferably at least 70%, and more preferably at least 90%. When the proportion of the divalent organic groups represented by general formula (4) as Ws is less than 50%, high thermal resistance cannot be achieved.

Ys in general formula (3) are divalent organic groups each having two or more carbon atoms, exclusive of the groups represented by general formula (4). The diamine compound capable of having such a configuration may be any diamine compound having no structure of general formula (4). Examples thereof include 3,4′-diaminodiphenyl ether, 4,4′-diaminodiphenylether, 3,4′-diaminodiphenylmethane, 4,4′-diaminodiphenylmethane, 3,4′-diaminodiphenyl sulfone, 4,4′-diaminodiphenyl sulfone, 3,4′-diaminodiphenyl sulfide, 4,4′-diaminodiphenyl sulfide, 1,4-bis(4-aminophenoxy)benzene, benzidine, 2,2′-bis(trifluoromethyl)benzidine, 3,3′-bis(trifluoromethyl)benzidine, 2,2′-dimethylbenzidine, 3,3′-dimethylbenzidine, 2,2′,3,3′-tetramethylbenzidine, m-phenylenediamine, p-phenylenediamine, 1,5-naphthalenediamine, 2,6-naphthalenediamine, bis(4-aminophenoxyphenyl)sulfone, bis(3-aminophenoxyphenyl)sulfone, bis(4-aminophenoxy)biphenyl, bis{4-(4-aminophenoxy)phenyl}ether, 1,4-bis(4-aminophenoxy)benzene, or compounds in which the aromatic ring thereof has been substituted with one or some alkyl groups or halogen atoms, aliphatic cyclohexyldiamines, and methylenebiscyclohexylamines. Of these, aromatic diamines are preferred in terms of thermal resistance. More preferred, a diamine compound mainly composed of organic groups each represented by general formula (8) or (9) is used as Y. R⁸ to R¹⁰ are each an organic group having 1 to 10 carbon atoms, examples of which include hydrocarbon groups having 1 to 10 carbon atoms, alkoxy groups having 1 to 10 carbon atoms, and the foregoing groups with one or some hydrogen atoms have been substituted with halogen or the like. Examples of diamine compounds capable of having such a configuration include m-phenylenediamine, p-phenylenediamine, benzidine, 2,2′-bis(trifluoromethyl)benzidine, 3,3′-bis(trifluoromethyl)benzidine, 2,2′-dimethylbenzidine, 3,3′-dimethylbenzidine, and 2,2′,3,3′-tetramethyl benzidine. It is preferred to use diamine compounds each mainly composed of organic groups each represented by general formula (8) or (9) as Ys in a proportion of at least 50%. The proportion is more preferably at least 70%, and more preferably at least 90%.

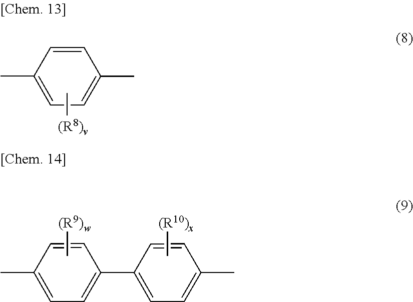

wherein in general formulae (8) and (9), R⁸ to R¹⁰ may be each a single monovalent C₁₋₁₀ organic group or a mixture of different monovalent C₁₋₁₀ organic groups; and v, w, and x are each an integer of 0 to 4.

Such diamine compounds can be used singly or two or more of them can be used in combination.

Zs in general formula (3) are mainly composed of tetravalent organic groups represented by general formula (5) or (6). R³ to R⁵ are each an organic group having 1 to 10 carbon atoms, examples of which include hydrocarbon groups having 1 to 10 carbon atoms, alkoxy groups having 1 to 10 carbon atoms, and the foregoing groups with one or some hydrogen atoms have been substituted with halogen or the like. Examples of acid dianhydrides capable of having such a configuration include pyromellitic dianhydride, 3,3′,4,4′-benzophenonetetracarboxylic dianhydride, and substituted derivatives thereof. Of these, pyromellitic dianhydride and 3,3′,4,4′-benzophenonetetracarboxylic dianhydride are preferred in terms of easy availability due to wide commercial availability. It is preferred to use tetravalent organic groups each represented by general formula (5) or (6) as Zs in a proportion of at least 50%. The proportion is more preferably at least 70%, and more preferably at least 90%. When the proportion of the tetravalent organic groups represented by general formulae (5) and (6) as Zs is less than 50%, high thermal resistance cannot be achieved.

On the other hand, Xs in general formula (2) are each a tetravalent organic group having two or more carbon atoms, exclusive of general formulae (5) and (6). The acid dianhydride capable of having such a configuration may be any acid dianhydride having no structure of general formulae (5) and (6). Examples thereof include aromatic tetracarboxylic dianhydrides such as 3,3′,4,4′-biphenyltetracarboxylic dianhydride, 2,3,3′,4′-biphenyltetracarboxylic dianhydride, 2,2′,3,3′-biphenyltetracarboxylic dianhydride, 2,2-bis(3,4-dicarboxyphenyl)propane dianhydride, 2,2-bis(2,3-dicarboxyphenyl)propane dianhydride, 1,1-bis(3,4-dicarboxyphenyl)ethane dianhydride, 1,1-bis(2,3-dicarboxyphenyl)ethane dianhydride, bis(3,4-dicarboxyphenyl)methane dianhydride, bis(2,3-dicarboxyphenyl)methane dianhydride, bis(3,4-dicarboxyphenyl)ether dianhydride, 2,2-bis(4-(4-aminophenoxy)phenyl)propane, 1,2,5,6-naphthalenetetracarboxylic dianhydride, 2,3,6,7-naphthalenetetracarboxylic dianhydride, 2,3,5,6-pyridinetetracarboxylic dianhydride, 3,4,9,10-perylenetetracarboxylic dianhydride, 2,2-bis(3,4-dicarboxyphenyl)hexafluoropropane dianhydride, 2,2-bis(4-(3,4-dicarboxyphenoxy)phenyl)hexafluoropropane dianhydride, 2,2-bis(4-(3,4-dicarboxy benzoyloxy)phenyl) hexafluoropropane dianhydride, 2,2′-bis(trifluoromethyl)-4,4′-bis(3,4-dicarboxyphenoxy)biphenyl dianhydride, and “RIKACID” (registered trademark) TMEG-100 (commercial name, produced by New Japan Chemical Co., Ltd.); and aliphatic tetracarboxylic dianhydrides such as cyclobutanetetracarboxylic dianhydride, 1,2,3,4-cyclopentanetetracarboxylic dianhydride, 2,3,5,6-cyclohexanetetracarboxylic dianhydride, 5-(2,5-dioxotetrahydro-3-furanyl)-3-methyl-3-cyclohexene-1,2-dicarboxylic anhydride, and “RIKACID” (registered trademark) TDA-100, BT-100 (commercial names, produced by New Japan Chemical Co., Ltd.). Of these, aromatic acid dianhydrides are preferred in terms of thermal resistance. Acid dianhydrides mainly composed of organic groups each represented by general formula (7) are more preferred as Xs. R⁶ and R⁷ are each an organic group having 1 to 10 carbon atoms, examples of which include hydrocarbon groups having 1 to 10 carbon atoms, alkoxy groups having 1 to 10 carbon atoms, and the foregoing groups with one or some hydrogen atoms have been substituted with halogen or the like. Examples of acid dianhydrides capable of having such a configuration include 3,3′,4,4′-biphenyltetracarboxylic dianhydride and substituted derivatives thereof. Of these, 3,3′,4,4′-biphenyltetracarboxylic dianhydride is preferred in terms of easy availability due to wide commercial availability. It is preferred to use acid dianhydrides each mainly composed of organic groups each represented by general formula (7) as Xs in a proportion of at least 50%. The proportion is more preferably at least 70%, and more preferably at least 90%.

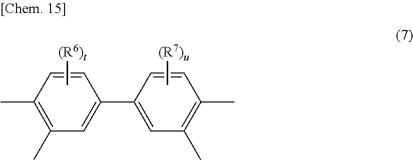

wherein in general formula (7), R⁶ and R⁷ may be each a single monovalent C₁₋₁₀ organic group or a mixture of different monovalent C₁₋₁₀ organic groups; and t and u are each an integer of 0 to 3.

Such acid dianhydrides can be used singly or two or more of them can be used in combination.

In a solution of a polyamic acid, a reaction in which an amic acid moiety of the acid dissociates to form an acid anhydride group and an amino group and a reaction in which they recombine are in equilibrium. However, if the resulting acid anhydride group reacts with water present in the solution, it will turn into a dicarboxylic acid, so that it will become unable to recombine with an amine. Therefore, there is a tendency that the presence of water drives the equilibrium towards dissociation of the polyamic acid and the degree of polymerization of the polyamic acid lowers, and as a result the viscosity of the solution often lowers.

Especially, the polyamic acid obtained by making a highly active acid dianhydride having a tetravalent organic group represented by general formula (5) or (6) to react with a diamine having a divalent organic group represented by general formula (4) allows a cured film to exhibit good thermal resistance, but the viscosity of a solution of the polyamic acid lowers greatly with time. On the other hand, a solution of a polyamic acid obtained by making a lowly active acid dianhydride react with a diamine having a divalent organic group represented by general formula (4) is slow in progress with time of decrease in viscosity. Then, the use of a highly active acid dianhydride and a diamine having a divalent organic group represented by general formula (4) for different blocks in a polyamic acid will allow a solution of the polyamic acid to maintain a stable viscosity. As a result, the storage stability of the polyamide acid solution is improved.

The polyamic acid having structures represented by general formula (1) in an amount of at least 80% of all the repeating units may be one with an end having been made to react with an end cap compound. A monoamine, a monohydric alcohol, an acid anhydride, a monocarboxylic acid, a monoacid chloride compound, a mono-active ester compound, and the like can be used as the end cap compound. A molecular weight can desirably be adjusted to within a preferable range by making an end cap compound react. Moreover, various organic groups can be introduced as an end group by making an end cap compound react.

Examples of the monoamine to be used as the end cap compound include, but are not limited to, 5-amino-8-hydroxyquinoline, 4-amino-8-hydroxyquinoline, 1-hydroxy-8-aminonaphthalene, 1-hydroxy-7-aminonaphthalene, 1-hydroxy-6-aminonaphthalene, 1-hydroxy-5-aminonaphthalene, 1-hydroxy-4-aminonaphthalene, 1-hydroxy-3-aminonaphthalene, 1-hydroxy-2-aminonaphthalene, 1-amino-7-hydroxynaphthalene, 2-hydroxy-7-aminonaphthalene, 2-hydroxy-6-aminonaphthalene, 2-hydroxy-5-aminonaphthalene, 2-hydroxy-4-aminonaphthalene, 2-hydroxy-3-aminonaphthalene, 1-amino-2-hydroxynaphthalene, 1-carboxy-8-aminonaphthalene, 1-carboxy-7-aminonaphthalene, 1-carboxy-6-aminonaphthalene, 1-carboxy-5-aminonaphthalene, 1-carboxy-4-aminonaphthalene, 1-carboxy-3-aminonaphthalene, 1-carboxy-2-aminonaphthalene, 1-amino-7-carboxynaphthalene, 2-carboxy-7-aminonaphthalene, 2-carboxy-6-aminonaphthalene, 2-carboxy-5-aminonaphthalene, 2-carboxy-4-aminonaphthalene, 2-carboxy-3-aminonaphthalene, 1-amino-2-carboxynaphthalene, 2-aminonicotinic acid, 4-aminonicotinic acid, 5-aminonicotinic acid, 6-aminonicotinic acid, 4-aminosalicylic acid, 5-aminosalicylic acid, 6-aminosalicylic acid, 3-amino-O-toluic acid, ammelide, 2-aminobenzoic acid, 3-aminobenzoic acid, 4-aminobenzoic acid, 2-aminobenzenesulfonic acid, 3-aminobenzenesulfonic acid, 4-aminobenzenesulfonic acid, 3-amino-4,6-dihydroxypyrimidine, 2-aminophenol, 3-aminophenol, 4-aminophenol, 5-amino-8-mercaptoquinoline, 4-amino-8-mercaptoquinoline, 1-mercapto-8-aminonaphthalene, 1-mercapto-7-aminonaphthalene, 1-mercapto-6-aminonaphthalene, 1-mercapto-5-aminonaphthalene, 1-mercapto-4-aminonaphthalene, 1-mercapto-3-aminonaphthalene, 1-mercapto-2-aminonaphthalene, 1-amino-7-mercaptonaphthalene, 2-mercapto-7-aminonaphthalene, 2-mercapto-6-aminonaphthalene, 2-mercapto-5-aminonaphthalene, 2-mercapto-4-aminonaphthalene, 2-mercapto-3-aminonaphthalene, 1-amino-2-mercaptonaphthalene, 3-amino-4,6-dimercaptopyrimidine, 2-aminothiophenol, 3-aminothiophenol, 4-aminothiophenol, 2-ethynylaniline, 3-ethynylaniline, 4-ethynylaniline, 2,4-diethynylaniline, 2,5-diethynylaniline, 2,6-diethynylaniline, 3,4-diethynylaniline, 3,5-diethynylaniline, 1-ethynyl-2-aminonaphthalene, 1-ethynyl-3-aminonaphthalene, 1-ethynyl-4-aminonaphthalene, 1-ethynyl-5-aminonaphthalene, 1-ethynyl-6-aminonaphthalene, 1-ethynyl-7-aminonaphthalene, 1-ethynyl-8-aminonaphthalene, 2-ethynyl-1-aminonaphthalene, 2-ethynyl-3-aminonaphthalene, 2-ethynyl-4-aminonaphthalene, 2-ethynyl-5-aminonaphthalene, 2-ethynyl-6-aminonaphthalene, 2-ethynyl-7-aminonaphthalene, 2-ethynyl-8-aminonaphthalene, 3,5-diethynyl-1-aminonaphthalene, 3,5-diethynyl-2-aminonaphthalene, 3,6-diethynyl-1-aminonaphthalene, 3,6-diethynyl-2-aminonaphthalene, 3,7-diethynyl-1-aminonaphthalene, 3,7-diethynyl-2-aminonaphthalene, 4,8-diethynyl-1-aminonaphthalene, and 4,8-diethynyl-2-aminonaphthalene.

Preferred among these are 5-amino-8-hydroxyquinoline, 1-hydroxy-7-aminonaphthalene, 1-hydroxy-6-aminonaphthalene, 1-hydroxy-5-aminonaphthalene, 1-hydroxy-4-aminonaphthalene, 2-hydroxy-7-aminonaphthalene, 2-hydroxy-6-aminonaphthalene, 2-hydroxy-5-aminonaphthalene, 1-carboxy-7-aminonaphthalene, 1-carboxy-6-aminonaphthalene, 1-carboxy-5-aminonaphthalene, 2-carboxy-7-aminonaphthalene, 2-carboxy-6-aminonaphthalene, 2-carboxy-5-aminonaphthalene, 2-aminobenzoic acid, 3-aminobenzoic acid, 4-aminobenzoic acid, 4-aminosalicylic acid, 5-aminosalicylic acid, 6-aminosalicylic acid, 2-aminobenzenesulfonic acid, 3-aminobenzenesulfonic acid, 4-aminobenzenesulfonic acid, 3-amino-4,6-dihydroxypyrimidine, 2-aminophenol, 3-aminophenol, 4-aminophenol, 2-aminothiophenol, 3-aminothiophenol, 4-aminothiophenol, 3-ethynylaniline, 4-ethynylaniline, 3,4-diethynylaniline, and 3,5-diethynylaniline.

Examples of the monohydric alcohol to be used as the end cap compound include, but are not limited to, methanol, ethanol, 1-propanol, 2-propanol, 1-butanol, 2-butanol, 1-pentanol, 2-pentanol, 3-pentanol, 1-hexanol, 2-hexanol, 3-hexanol, 1-heptanol, 2-heptanol, 3-heptanol, 1-octanol, 2-octanol, 3-octanol, 1-nonanol, 2-nonanol, 1-decanol, 2-decanol, 1-undecanol, 2-undecanol, 1-dodecanol, 2-dodecanol, 1-tridecanol, 2-tridecanol, 1-tetradecanol, 2-tetradecanol, 1-pentadecanol, 2-pentadecanol, 1-hexadecanol, 2-hexadecanol, 1-heptadecanol, 2-heptadecanol-, 1-octadecanol, 2-octadecanol, 1-nonadecanol, 2-nonadecanol, 1-icosanol, 2-methyl-1-propanol, 2-methyl-2-propanol, 2-methyl-1-butanol, 3-methyl-1-butanol, 2-methyl-2-butanol, 3-methyl-2-butanol, 2-propyl-1-pentanol, 2-ethyl-1-hexanol, 4-methyl-3-heptanol, 6-methyl-2-heptanol, 2,4,4-trimethyl-1-hexanol, 2,6-dimethyl-4-heptanol, isononyl alcohol, 3,7 dimethyl-3-octanol, 2,4-dimethyl-1-heptanol, 2-heptylundecanol, ethylene glycol monoethyl ether, ethylene glycol monomethyl ether, ethylene glycol monobutyl ether, propylene glycol 1-methyl ether, diethylene glycol monoethyl ether, diethylene glycol monomethyl ether, diethylene glycol monobutyl ether cyclopentanol, cyclohexanol, cyclopentane monomethylol, dicyclopentane monomethylol, tricyclodecane monomethylol, norborneol, and terpineol.

Of these, primary alcohols are preferred in terms of reactivity with acid dianhydrides.

Examples of an acid anhydride, a monocarboxylic acid, a monoacid chloride compound, and a mono-active ester compound to be used as the end cap compound include acid anhydrides such as phthalic anhydride, maleic anhydride, nasic anhydride, cyclohexane dicarboxylic anhydride, and 3-hydroxyphthalic acid anhydride; monocarboxylic acids such as 2-carboxyphenol, 3-carboxyphenol, 4-carboxyphenol, 2-carboxythiophenol, 3-carboxythiophenol, 4-carboxythiophenol, 1-hydroxy-8-carboxynaphthalene, 1-hydroxy-7-carboxynaphthalene, 1-hydroxy-6-carboxynaphthalene, 1-hydroxy-5-carboxynaphthalene, 1-hydroxy-4-carboxynaphthalene, 1-hydroxy-3-carboxynaphthalene, 1-hydroxy-2-carboxynaphthalene, 1-mercapto-8-carboxynaphthalene, 1-mercapto-7-carboxynaphthalene, 1-mercapto-6-carboxynaphthalene, 1-mercapto-5-carboxynaphthalene, 1-mercapto-4-carboxynaphthalene, 1-mercapto-3-carboxynaphthalene, 1-mercapto-2-carboxynaphthalene, 2-carboxybenzenesulfonic acid, 3-carboxybenzenesulfonic acid, 4-carboxybenzenesulfonic acid, 2-ethynylbenzoic acid, 3-ethynylbenzoic acid, 4-ethynylbenzoic acid, 2,4-diethynylbenzoic acid, 2,5-diethynylbenzoic acid, 2,6-diethynylbenzoic acid, 3,4-diethynylbenzoic acid, 3,5-diethynylbenzoic acid, 2-ethynyl-1-naphthoic acid, 3-ethynyl-1-naphthoic acid, 4-ethynyl-1-naphthoic acid, 5-ethynyl-1-naphthoic acid, 6-ethynyl-1-naphthoic acid, 7-ethynyl-1-naphthoic acid, 8-ethynyl-1-naphthoic acid, 2-ethynyl-2-naphthoic acid, 3-ethynyl-2-naphthoic acid, 4-ethynyl-2-naphthoic acid, 5-ethynyl-2-naphthoic acid, 6-ethynyl-2-naphthoic acid, 7-ethynyl-2-naphthoic acid, and 8-ethynyl-2-naphthoic acid, monoacid chloride compounds each resulting from the conversion of the carboxyl group of each of the foregoing into an acid chloride; monoacid chloride compounds each resulting from the conversion into an acid chloride of one carboxyl group of a dicarboxylic acid such as terephthalic acid, phthalic acid, maleic acid, cyclohexanedicarboxylic acid, 3-hydroxyphthalic acid, 5-norbornene-2,3-dicarboxylic acid, 1,2-dicarboxynaphthalene, 1,3-dicarboxynaphthalene, 1,4-dicarboxynaphthalene, 1,5-dicarboxynaphthalene, 1,6-dicarboxynaphthalene, 1,7-dicarboxynaphthalene, 1,8-dicarboxynaphthalene, 2,3-dicarboxynaphthalene, 2,6-dicarboxynaphthalene, and 2,7-dicarboxynaphthalene; and active ester compounds obtained as a result of a reaction of a monoacid chloride compound with N-hydroxybenzotriazole or N-hydroxy-5-norbornene-2,3-dicarboxylmide.

Of these, preferred are acid anhydrides such as phthalic anhydride, maleic anhydride, nasic anhydride, cyclohexane dicarboxylic anhydride, and 3-hydroxyphthalic acid anhydride; monocarboxylic acids such as 3-carboxyphenol, 4-carboxyphenol, 3-carboxythiophenol, 4-carboxythiophenol, 1-hydroxy-7-carboxynaphthalene, 1-hydroxy-6-carboxynaphthalene, 1-hydroxy-5-carboxynaphthalene, 1-mercapto-7-carboxynaphthalene, 1-mercapto-6-carboxynaphthalene, 1-mercapto-5-carboxynaphthalene, 3-carboxybenzenesulfonic acid, 4-carboxybenzenesulfonic acid, 3-ethynylbenzoic acid, 4-ethynylbenzoic acid, 3,4-diethynylbenzoic acid, and 3,5-diethynylbenzoic acid, and monoacid chloride compounds each resulting from the conversion of the carboxyl group of each of the foregoing into an acid chloride; monoacid chloride compounds each resulting from conversion into an acid chloride of one carboxyl group of a dicarboxylic acid such as terephthalic acid, phthalic acid, maleic acid, cyclohexanedicarboxylic acid, 1,5-dicarboxynaphthalene, 1,6-dicarboxynaphthalene, 1,7-dicarboxynaphthalene, and 2,6-dicarboxynaphthalene; and active ester compounds obtained as a result of a reaction of a monoacid chloride compound with N-hydroxybenzotriazole or N-hydroxy-5-norbornene-2,3-dicarboxylmide.

The introduction ratio of the monoamine to be used as an end cap compound is preferably within the range of 0.1 to 60 mol %, particularly preferably 5 to 50 mol % based on all amine components. The introduction ratio of the acid anhydride, monocarboxylic acid, monoacid chloride compound, and mono-active ester compound to be used as the end cap compound is preferably within the range of 0.1 to 100 mol %, particularly preferably 5 to 90 mol % based on the diamine component. It is permissible to introduce two or more different end groups by making two or more end cap compounds react.

The end cap compound having been introduced into a polyamic acid can be detected easily by the following method. For example, an end cap compound can be detected easily by dissolving a polymer into which the end cap compound has been introduced in an acidic solution to decompose the polymer into an amine component and an acid anhydride component which are structural units of the polymer, and then measuring them by gas chromatography (GC) or NMR. Alternatively, a polymer in which an end cap compound has been introduced can be detected easily and directly by the measurement of a thermal decomposition gas chromatograph (PGC), an infrared spectrum, and ¹³C-NMR spectrum.

The polyamic acid having structures represented by general formula (1) in an amount of at least 80% of all the repeating units is synthesized by the following method. Exemplary methods include a method in which a tetracarboxylic dianhydride and a diamine compound constituting block A are made to react first, and then a tetracarboxylic dianhydride and a diamine compound constituting block B are added and made to react, a method in which a tetracarboxylic dianhydride and a diamine compound constituting block B are made to react first, and then a tetracarboxylic dianhydride and a diamine compound constituting block A are added and made to react, and a method in which block A and block B are polymerized in separate vessels and then they are combined and made to react. Block A is made to be a polyamic acid block represented by general formula (2) by the following method. As to the proportions of the diamine compound constituted of W in general formula (2) and the acid dianhydride constituted of X, polymerization is carried out with the acid dianhydride constituted of X being present more. This method can convert both ends of block A into acid dianhydrides each constituted of X and can make block A have structures represented by general formula (2). On the other hand, block B is made to be a polyamic acid block represented by general formula (3) by the following method. As to the proportions of the diamine constituted of Y in general formula (3) and the acid dianhydride constituted of Z, polymerization is carried out with the diamine compound constituted of Y being present more. This method can convert both ends of block B into diamine compounds each constituted of Y and can make block B have structures represented by general formula (3).

Examples of the reaction solvent to be used in these known methods include N-methyl-2-pyrrolidone, N,N-dimethylacetamide, and γ-butyrolactone.

m in general formula (2) is the number of repetition of the structural units of block A, and n in general formula (3) is the number of repetition of the structural units of block B. As to the proportions of the sum total Σm of the number of repetition m of the structural units of block A and the sum total Σn of the number of repetition n of the structural units of block B in the polyamic acid having structures represented by general formula (1) in an amount of at least 80% of all the repeating units, they are preferably within the range of 0.1≦Σn/Σm≦10. When within this range, the proportions of the diamine compound represented by general formula (4) and the acid dianhydride represented by general formula (5) or (6) contained in the polyamic acid having structures represented by general formula (1) in an amount of at least 80% of all the repeating units are well balanced and a thermally treated film can be high in thermal resistance. More preferably, 0.2≦Σn/Σm≦5, and even more preferably, 0.5≦Σn/Σm≦2.

k in general formula (1) is the number of repetition of block A and block B. Preferably, the range of k satisfies 2≦k≦1000. When within this range, the weight average molecular weight of the polyamic acid having structures represented by general formula (1) in an amount of at least 80% of all the repeating units can be adjusted into a desirable range.

The weight average molecular weight of the polyamic acid having structures represented by general formula (1) in an amount of at least 80% of all the repeating units, which is determined in polystyrene equivalent by gel permeation chromatography, is preferably 2,000 or more, more preferably 3,000 or more, even more preferably 5,000 or more, and it is preferably 200,000 or less, more preferably 10,000 or less, and even more preferably 50,000 or less. When the weight average molecular weight is 2,000 or more, the thermal resistance and the mechanical strength of a cured film become better. In the case of being 200,000 or less, it is possible to inhibit the viscosity of the resin composition from increasing when the resin is dissolved at a high concentration in a solvent.

The resin composition of the present invention includes (b) one or some solvents.

Polar aprotic solvents such as N-methyl-2-pyrrolidone, γ-butyrolactone, N,N-dimethylformamide, N,N-dimethylacetamide, and dimethyl sulfoxide; ethers such as tetrahydrofuran, dioxane, and propylene glycol monomethyl ether; ketones such as acetone, methyl ethyl ketone, diisobutyl ketone, and diacetone alcohol; esters such as ethyl acetate, propylene glycol monomethyl ether acetate, and ethyl lactate; and aromatic hydrocarbons such as toluene and xylene may be used singly as the solvent, or two or more of them may be used in combination.

The content of the solvent per 100 parts by weight of the polyamic acid having structures represented by general formula (1) in an amount of at least 80% of all the repeating units is preferably 50 parts by weight or more, more preferably 100 parts by weight or more and it is preferably 2,000 parts by weight or less, more preferably 1,500 parts by weight or less. When the content is within the range of 50 to 2,000 parts by weight, a viscosity suitable for coating is afforded and the film thickness after coating can be controlled easily.

In order to further improve the thermal stability, the resin composition of the present invention may include (c) inorganic particles. Examples thereof include metal inorganic particles such as platinum, gold, palladium, silver, copper, nickel, zinc, aluminum, iron, cobalt, rhodium, ruthenium, tin, lead, bismuth, and tungsten, and metal oxide inorganic particles such as silicon oxide (silica), titanium oxide, aluminum oxide, zinc oxide, tin oxide, tungstic oxide, calcium carbonate, and barium sulfate. The shape of the inorganic particles (c) is not particularly restricted and examples thereof include a spherical shape, an elliptical shape, a flat shape, a rod shape, and a fibrous shape. In order to suppress the increase in surface roughness of a cured film of the resin composition containing the inorganic particles (c), the average particle diameter of the inorganic particles (c) is preferably smaller. The range of a preferable average particle diameter is 1 nm to 100 nm, more preferably 1 nm to 50 nm, and even more preferably 1 nm to 30 nm.

The content of the inorganic particles (c) is preferably 3 parts by weight or more, more preferably 5 parts by weight or more, even more preferably 10 parts by weight or more, and preferably 100 parts by weight or less, more preferably 80 parts by weight or less, even more preferably 50 parts by weight or less per 100 parts by weight of the polyamic acid (a) having structures represented by general formula (1) in an amount of at least 80% of all the repeating units. If the content of the inorganic particles (c) is 3 parts by weight or more, thermal resistance will improve enough, whereas if the content is 100 parts by weight or less, the toughness of a cured film will become less prone to deteriorate.

Various known methods can be used as a method for making the inorganic particles (c) to be contained. For example, it is permissible to make an organo inorganic particle sol to be contained. Organo inorganic particle sol is a material prepared by dispersing inorganic particles in an organic solvent. Examples of the organic solvent include methanol, isopropanol, normal butanol, ethylene glycol, methyl ethyl ketone, methyl isobutyl ketone, propylene glycol monomethyl ether acetate, propylene glycol monomethyl ether, N,N-dimethylacetamide, N,N-dimethylformamide, N-methyl-2-pyrrolidone, 1,3-dimethylimidazolidinone, and γ-butyrolactone.

The inorganic particles (c) may be ones having been subjected to surface treatment. Examples of the method of the surface treatment for the inorganic particles (C) include a method comprising treating an organo inorganic particle sol with a silane coupling agent. Various known methods can be used as a specific treating method; one example is a method in which a silane coupling agent is added to an organo inorganic particle sol, followed by stirring at room temperature to 80° C. for 0.5 to 2 hours.

The resin composition of the present invention can include one or some surfactants in order to improve its wettability with a substrate. Examples of the surfactant include fluorine-based surfactants, such as Fluorad (commercial name, produced by Sumitomo 3M Limited), Megaface (commercial name, produced by Dainippon Ink & Chemicals, Inc.), and Surflon (commercial name, produced by Asahi Glass Co., Ltd.). Further examples include organic siloxane surfactants, such as KP341 (commercial name, produced by Shin-Etsu Chemical Co., Ltd.), DBE (commercial name, produced by Chisso Corporation), Polyflow, Glanol (commercial names, produced by Kyoeisha Chemical Co., Ltd.), and BYK (produced by BYK-Chemie GmbH). Still further examples include acrylic polymer surfactants, such as Polyflow (commercial name, produced by Kyoeisha Chemical Co., Ltd.).

Preferably, such a surfactant is contained in an amount of 0.01 to 10 parts by weight per 100 parts by weight of the polyamic acid having structures represented by general formula (1) in an amount of at least 80% of all the repeating units.

Next, the method for producing the resin composition of the present invention is described. For example, the resin composition of the present invention can be obtained by mixing 1.01 to 2 mol-equivalent of a diamine compound represented by general formula (11) with 1 mol-equivalent of an acid dianhydride represented by general formula (10) and making them react, and then adding a diamine compound represented by general formula (12) and an acid dianhydride represented by general formula (13) in an amount of 1.01 to 2 mol-equivalent per 1 mol-equivalent of the diamine compound represented by general formula (12) and making them react.

The amount of the diamine represented by general formula (11) per 1 mol-equivalent of the acid dianhydride represented by general formula (10) is preferably 1.02 to 1.5 mol-equivalent, more preferably 1.05 to 1.3 mol-equivalent. The amount of the acid dianhydride represented by general formula (13) per 1-mol-equivalent of the diamine represented by general formula (12) is preferably 1.02 to 1.5 mol-equivalent, more preferably 1.05 to 1.3 mol-equivalent.

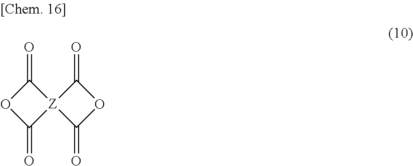

wherein in general formula (10), Zs are tetravalent organic groups having two or more carbon atoms and are mainly composed of tetravalent organic groups represented by general formula (5) or (6),

[Chem. 17]

H₂N—Y—NH₂ (11)

wherein in general formula (11), Ys are divalent organic groups each having two or more carbon atoms, exclusive of the groups represented by general formula (4),

[Chem. 18]

H₂N—W—NH₂ (12)

wherein in general formula (12), Ws are divalent organic groups each having two or more carbon atoms and are mainly composed of divalent organic groups represented by general formula (4),

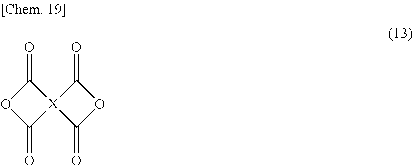

wherein in general formula (13), Xs are tetravalent organic groups each having two or more carbon atoms, exclusive of the groups represented by general formulae (5) and (6).

Alternatively, the resin composition of the present invention can be obtained by mixing 1.01 to 2 mol-equivalent of an acid dianhydride represented by general formula (13) with 1 mol-equivalent of a diamine compound represented by general formula (12) and making them react, and then adding an acid dianhydride represented by general formula (10) and a diamine compound represented by general formula (11) in an amount of 1.01 to 2 mol-equivalent per 1 mol-equivalent of the acid dianhydride represented by general formula (10) and making them react.

The amount of the acid dianhydride represented by general formula (13) per 1 mol-equivalent of the diamine compound represented by general formula (12) is preferably 1.02 to 1.5 mol-equivalent, more preferably 1.05 to 1.3 mol-equivalent. Moreover, the amount of the diamine represented by general formula (11) per 1 mol-equivalent of the acid dianhydride represented by general formula (10) is preferably 1.02 to 1.5 mol-equivalent, more preferably 1.05 to 1.3 mol-equivalent.

The resin composition of the present invention can be obtained by separately preparing a material resulting from mixing 1.01 to 2 mol-equivalent of a diamine compound represented by general formula (11) with 1 mol-equivalent of an acid dianhydride represented by general formula (10), followed by making them react and a material resulting from mixing 1.01 to 2 mol-equivalent of an acid dianhydride represented by general formula (13) with a diamine compound represented by general formula (12), followed by making them react, and then mixing both the materials, followed by making them react.

The amount of the diamine represented by general formula (11) per 1 mol-equivalent of the acid dianhydride represented by general formula (10) is preferably 1.02 to 1.5 mol-equivalent, more preferably 1.05 to 1.3 mol-equivalent. The amount of the acid dianhydride represented by general formula (13) per 1 mol-equivalent of the diamine represented by general formula (12) is preferably 1.02 to 1.5 mol-equivalent, more preferably 1.05 to 1.3 mol-equivalent.

Next, a method for producing a heat-resistant resin film using the resin composition of the present invention is described.

First, the resin composition is coated onto a substrate. Examples of the substrate to be used include, but are not limited to, silicon wafer, ceramics, gallium arsenic, soda lime glass, and non-alkali glass. Examples of the coating method include slit die coating method, spin coating method, spray coating method, roll coating method, and bar coating method; the coating may be performed by using these methods in combination.

Then, the substrate coated with the resin composition is dried to form a resin composition film. The drying is performed by using a hot plate, an oven, infrared rays, a vacuum chamber, or the like. In the use of a hot plate, an object to be heated is heated while being held on the plate directly or on a jig such as a proximity pin disposed on the plate. Examples of the material of the proximity pin include metallic materials such as aluminum and stainless steel and synthetic resins such as polyimide resin and “TEFLON (registered trademark),” and proximity pins made of any material may be used. The height of the proximity pin varies depending upon the size of the substrate, the type of the resin layer as the object to be heated, the purpose of heating, and so on; for example, when a resin layer coated on a glass substrate measuring 300 mm×350 mm×0.7 mm is to be heated, the height of the proximity pin is preferably from about 2 mm to about 12 mm. Although the heating temperature varies depending upon the type of the object to be heated and the purpose of heating, the heating is preferably performed at a temperature within the range from room temperature to 180° C. for one minute to several hours.

Then, a temperature is applied at within the range of from 180° C. to 500° C., so that the resin layer is converted into a heat-resistant resin film. While examples of the method of peeling off the heat-resistant resin film from the substrate include a method comprising immersion in a chemical solution such as fluoric acid and a method comprising irradiating the interface between the heat-resistant resin film and the substrate with a laser, any method may be used.

### EXAMPLES

The present invention will be described below with reference to examples, but the invention is not limited by these examples.

### (1) Measurement of Viscosity

Measurement was performed at 25° C. using a viscometer (TVE-22H manufactured by Toki Sangyo Co., Ltd.).

### (2) Measurement of Weight Average Molecular Weight

A weight average molecular weight was determined in polystyrene equivalent by a gel permeation chromatography (Waters 2690 manufactured by Waters Corporation). The columns used were TOSOH TXK-GEL α-2500 and α-4000 produced by Tosoh Corporation, and the mobile layer used was NMP.

### (3) Test Method for Storage Stability Evaluation

A resin composition (henceforth referred to as varnish) prepared in Example was adjusted using NMP so as to have a viscosity of 2850 to 3150 mPa·s. After the viscosity adjustment, a test was performed at 40° C. for 24 hours in a thermostatic chamber (Cool Incubator PCI-301 manufactured by AS ONE Corporation). (Henceforth, a sample before the execution of this test is called “before test” and a sample after the execution of the test is called “after test”.)

### (4) Calculation of Viscosity Change Factor

The viscosity of a varnish after a storage stability evaluation test was measured, and then a change factor was calculated using the following formula.

Change factor(%)=[(viscosity before test)−(viscosity after test)]/(viscosity before test)×100

### (5) Calculation of Weight Average Molecular Weight Change Factor

The weight average molecular weight of a varnish after a storage stability evaluation test was measured, and then a change factor was calculated using the following formula.

Change factor(%)=[(weight average molecular weight before test)−(weight average molecular weight after test)]/(weight average molecular weight before test)×100

### (6) Preparation of Heat-Resistant Resin Film

The varnish synthesized in Example was filtered under pressure using a 1-μm filter, thereby removing foreign matter. The filtered varnish was coated onto a 4-inch silicon wafer and subsequently prebaked at 150° C. for 3 minutes by using a hot plate (D-Spin manufactured by Dainippon Screen Mfg. Co., Ltd.), affording a prebaked film. The thickness of the film was adjusted so that it might be 10 μm after curing. The prebaked film was heat-treated at 350° C. for 30 minutes under nitrogen flow (with an oxygen concentration of 20 pm or less) by using an inert gas oven (INH-21CD manufactured by Koyo Thermo Systems Co., Ltd.), thereby preparing a heat-resistant resin. Subsequently, after immersion in fluoric acid for 4 minutes, the heat-resistant resin film was peeled off from the substrate and then air-dried. In Example 4 and Comparative Example 4, a film was formed on a silicon wafer sputtered with aluminum and the film was peeled off through immersion in hydrochloric acid.

### (7) Measurement of Glass Transition Temperature (Tg)

Measurement was performed by using a thermomechanical analyzer (EXSTAR6000TMA/SS6000 manufactured by SII NanoTechnology Inc.) under nitrogen flow. The rising of temperature was performed under the following conditions. The temperature was raised up to 150° C. in the first stage, thereby removing the adsorbed water of the sample, and then the temperature was lowered to room temperature in the second stage. In the third stage, the plenary measurement was performed at a temperature ramp-up rate of 5° C./min, thereby measuring a glass transition temperature.

### (8) Measurement of Coefficient of Thermal Expansion (CTE)

Measurement was performed in the same manner as the measurement of glass transition temperature, and then the average of coefficients of thermal expansion at 50 to 200° C. was calculated.

### (9) Measurement of Temperature of 5% Weight Loss (Td5)

The measurement was performed by using a thermogravimetric analyzer (TGA-50 manufactured by Shimadzu Corporation) under nitrogen flow. The rising of temperature was performed under the following conditions. The temperature was raised up to 150° C. in the first stage, thereby removing the adsorbed water of the sample, and then the temperature was lowered to room temperature in the second stage. In the third stage, the plenary measurement was performed at a temperature ramp-up rate of 10° C./min, thereby measuring a temperature of 5% heat weight loss.

The acronyms of the compounds used in Examples are as follows.

DABA: 4,4′-diaminobenzanilide
PDA: p-phenylenediamine
TFMB: 2,2′-bis(trifluoromethyl)benzidine,
DAE: 4,4′-diaminodiphenylether
PMDA: pyromellitic dianhydride
BTDA: 3,3′,4,4′-benzophenonetetracarboxylic dianhydride
BPDA: 3,3′,4,4′-biphenyltetracarboxylic dianhydride
ODPA: bis(3,4-dicarboxyphenyl)ether dianhydride
MAP: 3-aminophenol
HexOH: 1-hexanol
MA: maleic anhydride
NMP: N-methyl-2-pyrrolidone

### Example 1

Under dry nitrogen flow, 1.96 g (9 mmol) of PMDA, 1.08 g (10 mmol) of PDA, and 30 g of NMP were charged into a 100-mL four-neck flask, followed by heating at 50° C. and stirring. Two hours later, 2.05 g (9 mmol) of DABA and 3.24 g (11 mmol) of BPDA were added, followed by heating and stirring. Additional two hours later, 0.218 g (2 mmol) of MAP was added, followed by stirring. One hour later, cooling afforded varnish.

### Example 2

Under dry nitrogen flow, 1.96 g (9 mmol) of PMDA, 1.08 g (10 mmol) of PDA, and 30 g of NMP were charged into a 100-mL four-neck flask, followed by heating at 50° C. and stirring. Two hours later, 2.05 g (9 mmol) of DABA and 3.24 g (11 mmol) of BPDA were added, followed by heating and stirring. Additional two hours later, 0.204 g (2 mmol) of HexOH was added, followed by stirring. One hour later, cooling afforded varnish.

### Example 3

Under dry nitrogen flow, 1.96 g (9 mmol) of PMDA, 1.19 g (11 mmol) of PDA, and 30 g of NMP were charged into a 100-mL four-neck flask, followed by heating at 50° C. and stirring. Two hours later, 2.05 g (9 mmol) of DABA and 2.94 g (10 mmol) of BPDA were added, followed by heating and stirring. Additional two hours later, 0.196 g (2 mmol) of MA was added, followed by stirring. One hour later, cooling afforded varnish.

### Example 4

A material resulting from adding 6.53 g (i.e., 30 parts by weight relative to 100 parts by weight of a polyamic acid resin) of organosilica sol DMAC-ST (produced by Nissan Chemical Industries, Ltd., silica particle concentration: 20%) to 20 g of the varnish obtained in Example 3, followed by stirring, was prepared as a varnish.

### Example 5

Under dry nitrogen flow, 2.90 g (9 mmol) of BTDA, 1.08 g (10 mmol) of PDA, and 30 g of NMP were charged into a 100-mL four-neck flask, followed by heating at 50° C. and stirring. Two hours later, 2.05 g (9 mmol) of DABA and 3.24 g (11 mmol) of BPDA were added, followed by heating and stirring. Additional two hours later, 0.218 g (2 mmol) of MAP was added, followed by stirring. One hour later, cooling afforded varnish.

### Example 6

Under dry nitrogen flow, 1.96 g (9 mmol) of PMDA, 3.20 g (10 mmol) of TFMB, and 30 g of NMP were charged into a 100-mL four-neck flask, followed by heating at 50° C. and stirring. Two hours later, 2.05 g (9 mmol) of DABA and 3.24 g (11 mmol) of BPDA were added, followed by heating and stirring. Additional two hours later, 0.218 g (2 mmol) of MAP was added, followed by stirring. One hour later, cooling afforded varnish.

### Example 7

Under dry nitrogen flow, 1.96 g (9 mmol) of PMDA, 2.00 g (10 mmol) of DAE, and 30 g of NMP were charged into a 100-mL four-neck flask, followed by heating at 50° C. and stirring. Two hours later, 2.05 g (9 mmol) of DABA and 3.24 g (11 mmol) of BPDA were added, followed by heating and stirring. Additional two hours later, 0.218 g (2 mmol) of MAP was added, followed by stirring. One hour later, cooling afforded varnish.

### Example 8

Under dry nitrogen flow, 1.96 g (9 mmol) of PMDA, 1.08 g (10 mmol) of PDA, and 30 g of NMP were charged into a 100-mL four-neck flask, followed by heating at 50° C. and stirring. Two hours later, 2.05 g (9 mmol) of DABA and 3.41 g (11 mmol) of ODPA were added, followed by heating and stirring. Additional two hours later, 0.218 g (2 mmol) of MAP was added, followed by stirring. One hour later, cooling afforded varnish.

### Example 9

Under dry nitrogen flow, 1.96 g (9 mmol) of PMDA, 1.08 g (10 mmol) of PDA, and 30 g of NMP were charged into a 100-mL four-neck flask, followed by heating at 50° C. and stirring. Two hours later, 2.18 g (9.6 mmol) of DABA and 3.24 g (11 mmol) of BPDA were added, followed by heating and stirring. Additional two hours later, 0.0873 g (0.8 mmol) of MAP was added, followed by stirring. One hour later, cooling afforded varnish.

### Example 10

Under dry nitrogen flow, 1.96 g (9 mmol) of PMDA, 1.08 g (10 mmol) of PDA, and 30 g of NMP were charged into a 100-mL four-neck flask, followed by heating at 50° C. and stirring. Two hours later, 1.91 g (8.4 mmol) of DABA and 3.24 g (11 mmol) of BPDA were added, followed by heating and stirring. Additional two hours later, 0.349 g (3.2 mmol) of MAP was added, followed by stirring. One hour later, cooling afforded varnish.

### Example 11

Under dry nitrogen flow, 2.05 g (9 mmol) of DABA, 3.24 g (11 mmol) of BPDA, and 30 g of NMP were charged into a 100-mL four-neck flask, followed by heating at 50° C. and stirring. Two hours later, 1.96 g (9 mmol) of PMDA and 1.08 g (10 mmol) of PDA were added, followed by heating and stirring. Additional two hours later, 0.218 g (2 mmol) of MAP was added, followed by stirring. One hour later, cooling afforded varnish.

### Example 12

Under dry nitrogen flow, 1.96 g (9 mmol) of PMDA, 1.08 g (10 mmol) of PDA, and 15 g of NMP were charged into a 100-mL four-neck flask, followed by heating at 50° C. and stirring. Into another 100-mL four-neck flask were charged 2.05 g (9 mmol) of DABA, 3.24 g (11 mmol) of BPDA, and 15 g of NMP, followed by heating at 50° C. and stirring. Two hours later, both were mixed and then heated and stirred. Additional two hours later, 0.218 g (2 mmol) of MAP was added, followed by stirring. One hour later, cooling afforded varnish.

### Comparative Example 1

Under dry nitrogen flow, 1.96 g (9 mmol) of PMDA, 1.08 g (10 mmol) of PDA, 2.05 g (9 mmol) of DABA, 3.24 g (11 mmol) of BPDA, and 30 g of NMP were charged into a 100-mL four-neck flask, followed by heating at 50° C. and stirring. Two hours later, 0.218 g (2 mmol) of MAP was added, followed by stirring. One hour later, cooling afforded varnish.

### Comparative Example 2

Under dry nitrogen flow, 1.96 g (9 mmol) of PMDA, 1.08 g (10 mmol) of PDA, 2.05 g (9 mmol) of DABA, 3.24 g (11 mmol) of BPDA, and 30 g of NMP were charged into a 100-mL four-neck flask, followed by heating at 50° C. and stirring. Two hours later, 0.204 g (2 mmol) of HexOH was added, followed by stirring. One hour later, cooling afforded varnish.

### Comparative Example 3

Under dry nitrogen flow, 1.96 g (9 mmol) of PMDA, 1.19 g (11 mmol) of PDA, 2.05 g (9 mmol) of DABA, 2.94 g (10 mmol) of BPDA, and 30 g of NMP were charged into a 100-mL four-neck flask, followed by heating at 50° C. and stirring. Two hours later, 0.196 g (2 mmol) of MA was added, followed by stirring. One hour later, cooling afforded varnish.

### Comparative Example 4

A material resulting from adding 6.53 g (i.e., 30 parts by weight relative to 100 parts by weight of a polyamic acid resin) of organosilica sol DMAC-ST to 20 g of the varnish obtained in Comparative Example 3, followed by stirring, was prepared as a varnish.

### Comparative Example 5

Under dry nitrogen flow, 2.90 g (9 mmol) of BTDA, 1.08 g (10 mmol) of PDA, 2.05 g (9 mmol) of DABA, 3.24 g (11 mmol) of BPDA, and 30 g of NMP were charged into a 100-mL four-neck flask, followed by heating at 50° C. and stirring. Two hours later, 0.218 g (2 mmol) of MAP was added, followed by stirring. One hour later, cooling afforded varnish.

### Comparative Example 6

Under dry nitrogen flow, 1.96 g (9 mmol) of PMDA, 3.20 g (10 mmol) of TFMB, 2.05 g (9 mmol) of DABA, 3.24 g (11 mmol) of BPDA, and 30 g of NMP were charged into a 100-mL four-neck flask, followed by heating at 50° C. and stirring. Two hours later, 0.218 g (2 mmol) of MAP was added, followed by stirring. One hour later, cooling afforded varnish.

### Comparative Example 7

Under dry nitrogen flow, 1.96 g (9 mmol) of PMDA, 2.00 g (10 mmol) of DAE, 2.05 g (9 mmol) of DABA, 3.24 g (11 mmol) of BPDA, and 30 g of NMP were charged into a 100-mL four-neck flask, followed by heating at 50° C. and stirring. Two hours later, 0.218 g (2 mmol) of MAP was added, followed by stirring. One hour later, cooling afforded varnish.

### Comparative Example 8

Under dry nitrogen flow, 1.96 g (9 mmol) of PMDA, 1.08 g (10 mmol) of PDA, 2.05 g (9 mmol) of DABA, 3.41 g (11 mmol) of ODPA, and 30 g of NMP were charged into a 100-mL four-neck flask, followed by heating at 50° C. and stirring. Two hours later, 0.218 g (2 mmol) of MAP was added, followed by stirring. One hour later, cooling afforded varnish.

### Comparative Example 9

Under dry nitrogen flow, 1.59 g (7 mmol) of DABA, 2.35 g (8 mmol) of BPDA, and 30 g of NMP were charged into a 100-mL four-neck flask, followed by heating at 50° C. and stirring. Two hours later, 0.757 g (7 mmol) of PDA and 1.53 g (7 mmol) of PMDA were added, followed by heating and stirring. Additional two hours later, 1.00 g (5 mmol) of DAE and 1.55 g (5 mmol) of ODPA were added, followed by excessively heating and stirring. Then, two hours later, 0.218 g (2 mmol) of MAP was added, followed by stirring. One hour later, cooling afforded varnish.

The configurations of the varnishes synthesized in Examples 1 to 12 and Comparative Examples 1 to 9 are shown in Tables 1 and 2. The result of the storage stability evaluation performed using these varnishes and the results of the measurements of the glass transition temperature, the coefficient of thermal expansion, and the temperature of 5% heat weight loss of the heat-resistant resin films obtained from those varnishes are shown in Table 3.

TABLE 1

| Resin composition (Each numerical value is the proportion of a monomer.) | | | | | | | | | | | | |
|---|---|---|---|---|---|---|---|---|---|---|---|---|
| | | | | Block A | | | Block B | | | | | |
| | End | | | Diamine W | Acid dianhydride X | | Diamine Y | | | Acid dianhydride Z | | |
| | MAP | HexOH | MA | DABA | BPDA | ODPA | PDA | TFMB | DAE | PMDA | BTDA | Remarks |
| Example 1 | 10 | | | 45 | 55 | | 50 | | | 45 | | |
| Example 2 | | 10 | | 45 | 55 | | 50 | | | 45 | | |
| Example 3 | | | 10 | 45 | 50 | | 55 | | | 45 | | |
| Example 4 | | | 10 | 45 | 50 | | 55 | | | 45 | | Addition of |
| | | | | | | | | | | | | silica particles |
| | | | | | | | | | | | | to Example 3 |
| Example 5 | 10 | | | 45 | 55 | | 50 | | | | 45 | |
| Example 6 | 10 | | | 45 | 55 | | | 50 | | 45 | | |
| Example 7 | 10 | | | 45 | 55 | | | | 50 | 45 | | |
| Example 8 | 10 | | | 45 | | 55 | 50 | | | 45 | | |
| Example 9 | 4 | | | 48 | 55 | | 50 | | | 45 | | |
| Example | 16 | | | 42 | 55 | | 50 | | | 45 | | |
| 10 | | | | | | | | | | | | |
| Example | 10 | | | 45 | 55 | | 50 | | | 45 | | Production method |
| 11 | | | | | | | | | | | | different from those of |
| | | | | | | | | | | | | Examples 1 and 9. |
| Examples | 10 | | | 45 | 55 | | 50 | | | 45 | | Production method |
| 12 | | | | | | | | | | | | different from those of |
| | | | | | | | | | | | | Examples 1 and 8. |

TABLE 2

| Resin composition (Each numerical value is the proportion of a monomer.) | | | | | | | | | | | | |
|---|---|---|---|---|---|---|---|---|---|---|---|---|
| | End | | | Diamine W | Acid dianhydride X | | Diamine Y | | | Acid dianhydride Z | | |
| | MAP | HexOH | MA | DABA | BPDA | ODPA | PDA | TFMB | DAE | PMDA | BTDA | Remarks |
| Comparative | 10 | | | 45 | 55 | | 50 | | | 45 | | Random copolymerization |
| Example 1 | | | | | | | | | | | | of Example 1 |
| Comparative | | 10 | | 45 | 55 | | 50 | | | 45 | | Random copolymerization |
| Example 2 | | | | | | | | | | | | of Example 2 |
| Comparative | | | 10 | 45 | 50 | | 55 | | | 45 | | Random copolymerization |
| Example 3 | | | | | | | | | | | | of Example 3 |
| Comparative | | | 10 | 45 | 50 | | 55 | | | 45 | | Addition of silica particles |
| Example 4 | | | | | | | | | | | | to Comparative Example 3 |
| Comparative | 10 | | | 45 | 55 | | 50 | | | | 45 | Random copolymerization |
| Example 5 | | | | | | | | | | | | of Example 5 |
| Comparative | 10 | | | 45 | 55 | | | 50 | | 45 | | Random copolymerization |
| Example 6 | | | | | | | | | | | | of Example 6 |
| Comparative | 10 | | | 45 | 55 | | | | 50 | 45 | | Random copolymerization |
| Example 7 | | | | | | | | | | | | of Example 7 |
| Comparative | 10 | | | 45 | | 55 | 50 | | | 45 | | Random copolymerization |
| Example 8 | | | | | | | | | | | | of Example 8 |
| Comparative | 10 | | | 35 | 40 | | 35 | | | 35 | | Block copolymer prepared |
| Example 9 | | | | | | | | | | | | by making ODPA(25)/DAE |
| | | | | | | | | | | | | (25) react with the |
| | | | | | | | | | | | | composition shown on |
| | | | | | | | | | | | | the left. |

TABLE 3

| | Results of storage stability evaluation | | | | | | Results of thermal | | |
|---|---|---|---|---|---|---|---|---|---|
| | Viscosity | | | Weight average molecular weight | | | resistance evaluation | | |
| | Before test | After test | Change | Before | After | Change | Tg | CTE | Td5 |
| | (mPa · s) | (mPa · s) | factor | test | test | factor | (° C.) | (ppm) | (° C.) |
| Example 1 | 3050 | 2710 | 11.1% | 43600 | 41700 | 4.4% | 388 | 2 | 579 |
| Example 2 | 3000 | 2630 | 12.3% | 45000 | 42900 | 4.7% | 390 | 2 | 576 |
| Example 3 | 3020 | 2570 | 14.9% | 58800 | 54900 | 6.6% | 347 | 8 | 571 |
| Example 4 | 3060 | 2710 | 11.4% | — | — | — | 346 | 5 | 580 |
| Example 5 | 3020 | 2380 | 21.2% | 81400 | 73600 | 9.6% | 351 | 10 | 561 |
| Example 6 | 2900 | 2650 | 8.6% | 61800 | 59600 | 3.6% | 343 | 8 | 568 |
| Example 7 | 3110 | 2800 | 10.0% | 71900 | 67200 | 6.5% | 301 | 23 | 560 |
| Example 8 | 2970 | 2470 | 16.8% | 41000 | 38800 | 5.4% | 356 | 16 | 567 |
| Example 9 | 2990 | 2550 | 14.7% | 92600 | 86500 | 6.6% | 391 | 1 | 580 |
| Example 10 | 3000 | 2830 | 5.7% | 18800 | 18300 | 2.7% | 382 | 2 | 575 |
| Example 11 | 3100 | 2740 | 11.6% | 45000 | 42900 | 4.7% | 388 | 2 | 577 |
| Example 12 | 3060 | 2700 | 11.8% | 43100 | 41000 | 4.9% | 390 | 3 | 577 |
| Comparative | 3010 | 1540 | 48.8% | 40000 | 29500 | 26.3% | 390 | 1 | 576 |
| Example 1 | | | | | | | | | |
| Comparative | 3070 | 1440 | 53.1% | 44600 | 31300 | 29.8% | 390 | 2 | 577 |
| Example 2 | | | | | | | | | |
| Comparative | 2980 | 2070 | 30.5% | 59700 | 50100 | 16.1% | 348 | 7 | 571 |
| Example 3 | | | | | | | | | |
| Comparative | 3000 | 2410 | 19.7% | — | — | — | 345 | 5 | 581 |
| Example 4 | | | | | | | | | |
| Comparative | 3040 | 1490 | 51.0% | 75300 | 57400 | 23.8% | 353 | 10 | 561 |
| Example 5 | | | | | | | | | |
| Comparative | 3010 | 1840 | 38.9% | 71900 | 61100 | 15.0% | 339 | 9 | 566 |
| Example 6 | | | | | | | | | |
| Comparative | 3000 | 2190 | 27.0% | 65000 | 59400 | 8.6% | 303 | 23 | 558 |
| Example 7 | | | | | | | | | |
| Comparative | 3030 | 2150 | 29.0% | 41800 | 37600 | 10.0% | 360 | 17 | 564 |
| Example 8 | | | | | | | | | |
| Comparative | 2970 | 2740 | 7.7% | 38600 | 37100 | 3.9% | 280 | 35 | 565 |
| Example 9 | | | | | | | | | |

### Example 13, Comparative Example 10

The varnishes of Example 1 and Comparative Example 1 before the storage stability evaluation test were each spin-coated on a silicon wafer at 1500 rpm for 30 seconds. Then, prebaked films were obtained by prebaking at 150° C. for 3 minutes. The measurement of the thickness of the prebaked films revealed that the prebaked film (Example 13) obtained from Example 1 had a thickness of 12.5 μm and the prebaked film (Comparative Example 10) obtained from Comparative Example 1 had a thickness of 12.2. Subsequently, films were produced using the varnishes after the storage stability evaluation test. The prebaked film (Example 13) obtained from Example 1 was 11.5 in thickness, whereas the prebaked film (Comparative Example 10) obtained from Comparative Example 1 was only 8.3 μm in thickness.

### INDUSTRIAL APPLICABILITY

According to the present invention, there can be provided a polyamic acid resin composition which exhibits excellent storage stability and which can afford a thermally treated film having excellent heat resistance. The thermally treated film can be used suitably for, e.g., flexible substrates of a flat-panel display, an electronic papers, and a solar battery, a surface protective coat of a semiconductor element, a dielectric film among layers, an insulation layer or spacer layer of an organic electro-luminescence device (organic EL element), a planarization layer of a thin film transistor substrate, an insulation layer of an organic transistor, a flexible printed circuit board, and a binder for electrodes of a lithium ion secondary battery.

1. A resin composition comprising (a) a polyamic acid which comprises structures represented by general formula (1) in an amount of at least 80% of all the repeating units and (b) one or some solvents, 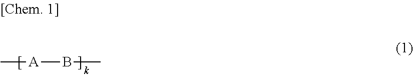
wherein in general formula (1), A is a polyamic acid block represented by general formula (2); B is a polyamic acid block represented by general formula (3); and k is a positive integer, 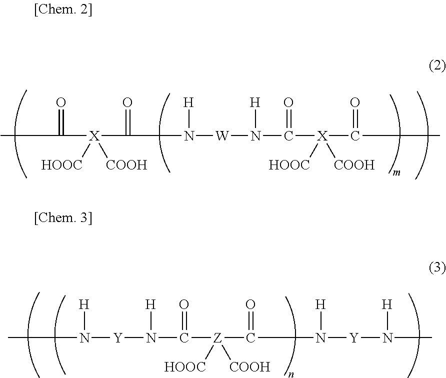
wherein in general formula (2), Ws are divalent organic groups each having two or more carbon atoms and are mainly composed of divalent organic groups represented by general formula (4); Xs are tetravalent organic groups each having two or more carbon atoms, exclusive of the groups represented by general formulae (5) and (6), while in general formula (3), Ys are divalent organic groups each having two or more carbon atoms, exclusive of the groups represented by general formula (4); Zs are tetravalent organic groups each having two or more carbon atoms and are mainly composed of tetravalent organic groups represented by general formula (5) or (6); in general formulae (2) and (3), ms and ns are positive numbers respectively, and may be respectively different among blocks, 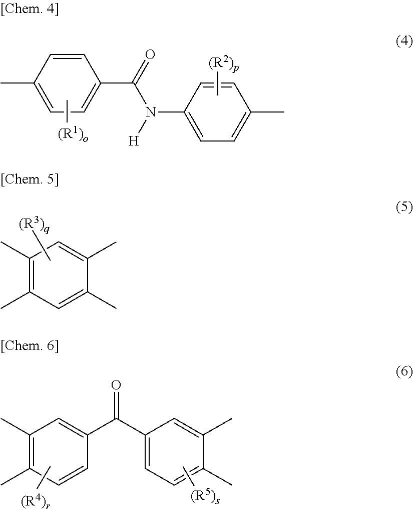
wherein in general formulae (4) to (6), R¹ to R⁵ may be each a single monovalent C₁₋₁₀ organic group or a mixture of different monovalent C₁₋₁₀ organic groups; o and p are each an integer of 0 to 4; q is an integer of 0 to 2; and r and s are each an integer of 0 to 3.

2. The resin composition according to claim 1, wherein Xs in general formula (2) are mainly composed of organic groups represented by general formula (7), 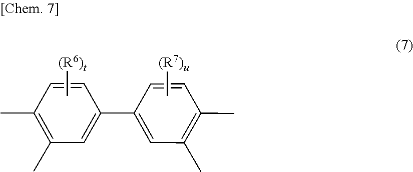
wherein in general formula (7), R⁶ and R⁷ may be each a single monovalent C₁₋₁₀ organic group or a mixture of different monovalent C₁₋₁₀ organic groups; and t and u are each an integer of 0 to 3.

3. The resin composition according to claim 1 or 2, wherein Ys in general formula (3) are mainly composed of organic groups represented by general formula (8) or (9), 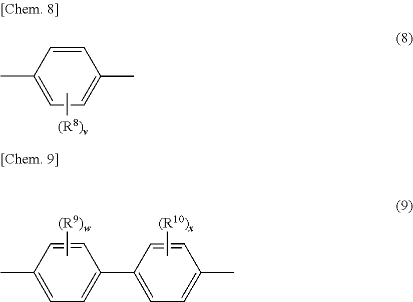
wherein in general formulae (8) and (9), R⁸ to R¹⁰ may be each a single monovalent C₁₋₁₀ organic group or a mixture of different monovalent C₁₋₁₀ organic groups; and v, w, and x are each an integer of 0 to 4.

4. The resin composition according to claim 1, further comprising (c) inorganic particles.

5. A method for producing a resin composition, wherein the method comprises mixing 1.01 to 2 mol-equivalent of a diamine compound represented by general formula (11) with 1 mol-equivalent of an acid dianhydride represented by general formula (10) and making them react, and then adding a diamine compound represented by general formula (12) and an acid dianhydride represented by general formula (13) in an amount of 1.01 to 2 mol-equivalent per 1 mol-equivalent of the diamine compound represented by general formula (12) and making them react, 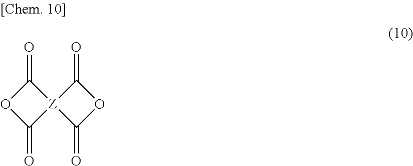
wherein in general formula (10), Zs are tetravalent organic groups having two or more carbon atoms and are mainly composed of tetravalent organic groups represented by general formula (5) or (6),
[Chem. 11]
H₂N—Y—NH₂ (11)
wherein in general formula (11), Ys are divalent organic groups each having two or more carbon atoms, exclusive of the groups represented by general formula (4),
[Chem. 12]
H₂N—W—NH₂ (12)
wherein in general formula (12), Ws are divalent organic groups each having two or more carbon atoms and are mainly composed of divalent organic groups represented by general formula (4), 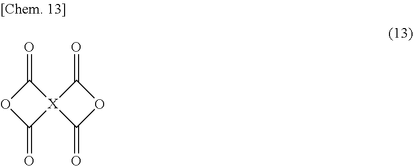
wherein in general formula (13), Xs are tetravalent organic groups each having two or more carbon atoms, exclusive of the groups represented by general formulae (5) and (6), 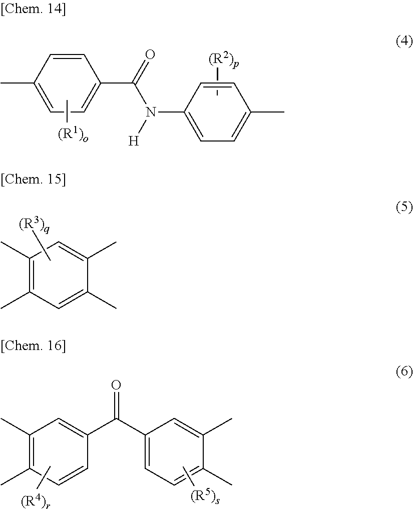
wherein in general formulae (4) to (6), R¹ to R⁵ may be each a single monovalent C₁₋₁₀ organic group or a mixture of different monovalent C₁₋₁₀ organic groups; o and p are each an integer of 0 to 4; q is an integer of 0 to 2; and r and s are each an integer of 0 to 3.

6. A method for producing a resin composition, wherein the method comprises mixing 1.01 to 2 mol-equivalent of an acid dianhydride represented by general formula (13) with 1 mol-equivalent of a diamine compound represented by general formula (12) and making them react, and then adding an acid dianhydride represented by general formula (10) and a diamine compound represented by general formula (11) in an amount of 1.01 to 2 mol-equivalent per 1 mol-equivalent of the acid dianhydride represented by general formula (10) and making them react, 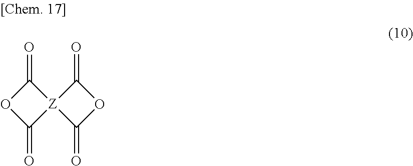
wherein in general formula (10), Zs are tetravalent organic groups having two or more carbon atoms and are mainly composed of tetravalent organic groups represented by general formula (5) or (6),
[Chem. 18]
H₂N—Y—NH₂ (11)
wherein in general formula (11), Ys are divalent organic groups having two or more carbon atoms, exclusive of the groups represented by general formula (4),
[Chem. 19]
H₂N—W—NH₂ (12)
wherein in general formula (12), Ws are divalent organic groups each having two or more carbon atoms and are mainly composed of divalent organic groups represented by general formula (4), 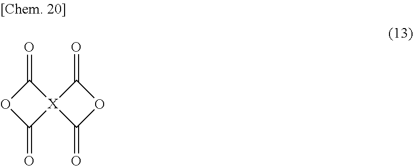
wherein in general formula (13), Xs are tetravalent organic groups each having two or more carbon atoms, exclusive of the groups represented by general formulae (5) and (6), 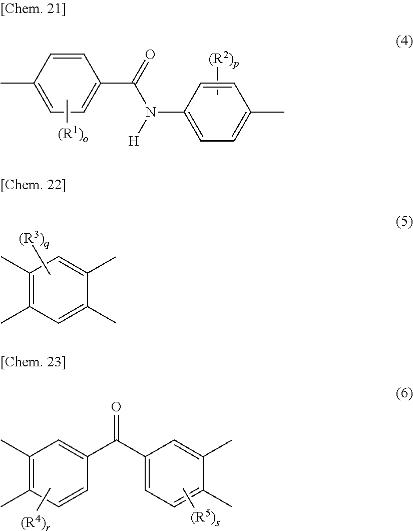
wherein in general formulae (4) to (6), R¹ to R⁵ may be each a single monovalent C₁₋₁₀ organic group or a mixture of different monovalent C₁₋₁₀ organic groups; o and p are each an integer of 0 to 4; q is an integer of 0 to 2; and r and s are each an integer of 0 to 3.

7. A method for producing a resin composition, wherein the method comprises separately preparing a material resulting from mixing 1.01 to 2 mol-equivalent of a diamine compound represented by general formula (11) with 1 mol-equivalent of an acid dianhydride represented by general formula (10), followed by making them react and a material resulting from mixing 1.01 to 2 mol-equivalent of an acid dianhydride represented by general formula (13) with a diamine compound represented by general formula (12), followed by making them react, and then mixing both the materials, followed by making them react, 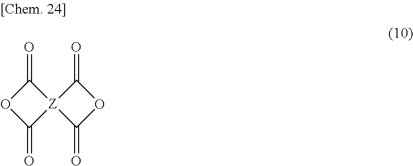
wherein in general formula (10), Zs are tetravalent organic groups having two or more carbon atoms and are mainly composed of tetravalent organic groups represented by general formula (5) or (6),
[Chem. 25]
H₂N—Y—NH, (11)
wherein in general formula (11), Ys are divalent organic groups each having two or more carbon atoms, exclusive of the groups represented by general formula (4),
[Chem. 26]
H₂N—W—NH₂ (12)
wherein in general formula (12), Ws are divalent organic groups each having two or more carbon atoms and are mainly composed of divalent organic groups represented by general formula (4), 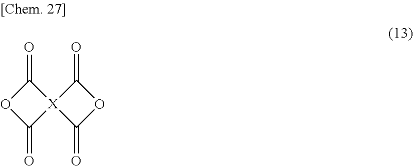
wherein in general formula (13), Xs are tetravalent organic groups each having two or more carbon atoms, exclusive of the groups represented by general formulae (5) and (6), 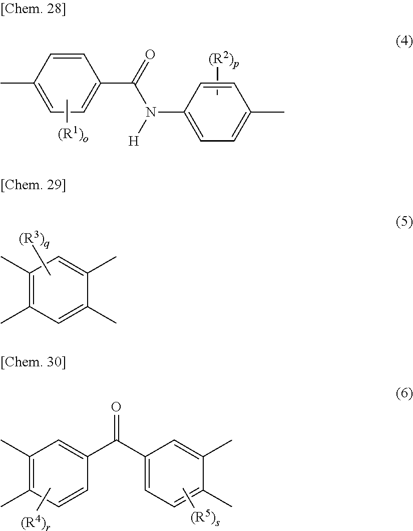
wherein in general formulae (4) to (6), R¹ to R⁵ may be each a single monovalent C₁₋₁₀ organic group or a mixture of different monovalent C₁₋₁₀ organic groups; o and p are each an integer of 0 to 4; q is an integer of 0 to 2, and r and s are each an integer of 0 to 3.
